(19) United States
(12) Patent Application Publication
(10) Pub. No.: US 2009/0102637 A1
(43) Pub. Date: Apr. 23, 2009

(54) SYSTEM AND METHOD FOR MANAGING AGENDAS IN A MOBILE DEVICE

(75) Inventor: SHIH-HSIUNG HSU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/195,407

(22) Filed: Aug. 20, 2008

(30) Foreign Application Priority Data
Oct. 22, 2007 (CN) 200710202197.7

(51) Int. Cl. G08B 23/00

(52) U.S. Cl. 340/500

(57) ABSTRACT

A system for managing agendas in a mobile device including a GPS is provided. The system includes various software modules to remind a user about agendas when all alarm conditions of the agendas have been satisfied. The alarm conditions of the agenda include an alarm active vicinity and an alarm active time period.

### BACKGROUND

1. Field of the Invention

Embodiments of the present disclosure relates to systems and methods for managing agendas, and more particularly to a system and method for managing agendas in a mobile device.

2. Description of Related Art

Presently, mobile telephones are widely used because of their multi-functional services and other conveniences. A mobile telephone can help the user keep in contact with his family and friends, and also can be used as a dictionary, a media player, a camera, a calendar, and so on.

It is well known that the calendar in the mobile telephone provides a function for a user to preset at least one agenda, and an alarm time of reminding the at least one agenda. when the preset alarm time reaches, the mobile telephone would remind the user about the preset agenda via an alarm output mode, i.e., a preset ring mode. However, at present, the agenda can only preset to be reminded according to the alarm time, which may not be the best solution sometimes.

What is needed, therefore, is an improved system and method for managing agendas.

### SUMMARY

A system for managing agendas in a mobile device comprising a GPS is provided. The system includes: a setting module, a storing module, a positioning module, a trigger alarm module, and a reminding module. The setting module is configured for setting at least one agenda, and setting alarm conditions for the at least one agenda, the alarm conditions comprising an alarm active vicinity. The storing module is configured for storing the at least one agenda and the alarm conditions of the at least one agenda. The positioning module is configured for receiving positioning signals from the GPS, and determining a current location of the mobile device according to the positioning signals. The trigger alarm module is configured for detecting if all the alarm conditions of the at least agenda have been satisfied. The reminding module is configured for reminding a user about the agenda when all the alarm conditions of the agenda have been satisfied.

Other advantages and novel features will become more apparent from the following detailed description certain inventive embodiments of the present disclosure when taken in conjunction with the accompanying drawings, in which:

### BRIEF DESCRIPTION OF THE DRAWINGS

FIG. 1 is a block diagram of one embodiment of software modules of a system for managing agendas in a mobile device;

FIG. 2 and FIG. 3 illustrates one example of a graphical user interface showing an agenda on the mobile telephone; and

FIG. 4 is a flowchart illustrating one embodiment of a method for managing agendas in a mobile device.

### DETAILED DESCRIPTION OF CERTAIN INVENTIVE EMBODIMENTS

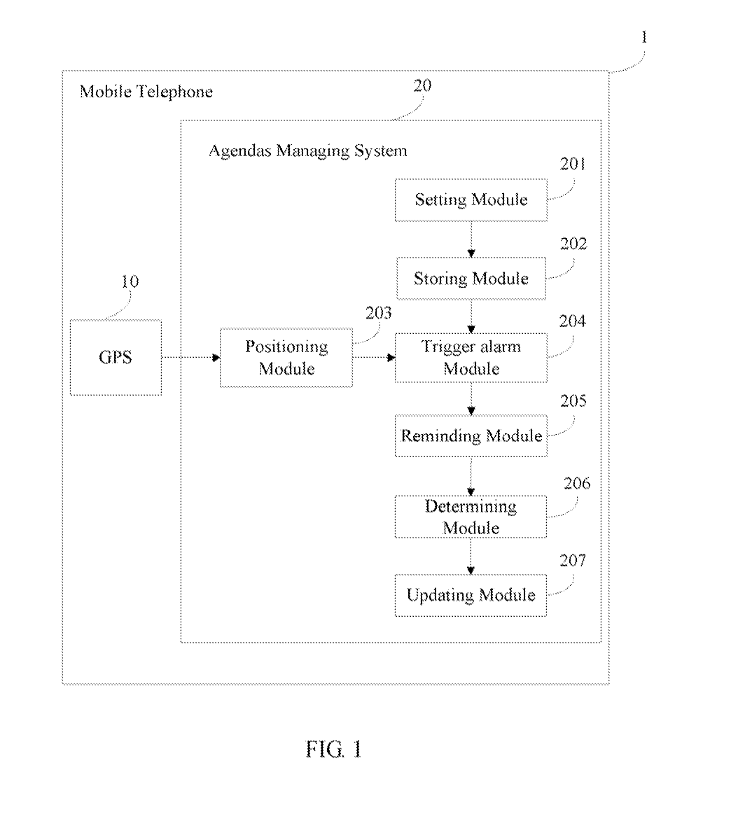

FIG. 1 is a block diagram of one embodiment of software function modules of a system 20 for managing agendas. The system 20 is installed in a mobile device having a global position system (GPS) 10. In one embodiment, the mobile device may be a notebook, a personal digital assistant (PDA), or a mobile telephone 1, for example. The system 20 includes a plurality of software function modules that are configured for reminding a user of the mobile telephone 1 about an agenda. Further details of the software function modules of the system 20 will be explained as follows.

In one embodiment, the system 20 may include a setting module 201, a storing module 202, a positioning module 203, a trigger alarm module 204, a reminding module 205, a determining module 206, and an updating module 207. It may be understood that one or more specialized or general purpose processors (not shown) in the mobile telephone 1 may be used to execute the software function modules 201, 202, 203, 204, 205, 206, 207.

The setting module 201 is configured for setting at least one agenda for a user, and setting alarm conditions for the at least one agenda. In one embodiment, the alarm conditions may include an alarm active vicinity and/or an alarm active time period as will be further defined herein. Furthermore, the setting module is further configured for setting an alarm title for the at least one agenda. It may be understood that the alarm active vicinity may warn a user of the mobile telephone that an approaching location is nearing the user. It may be further understood that the alarm active time period may define a period of time that an alarm of the mobile telephone 1 may be active. Further details of the alarm active vicinity and the alarm active period will be described in detail below.

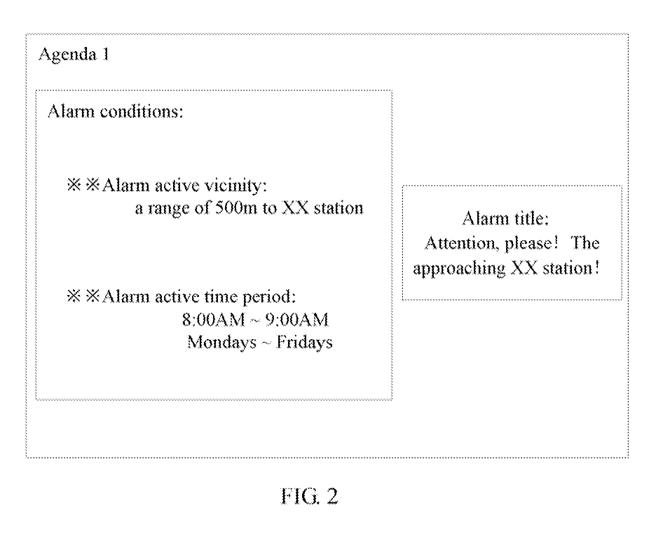

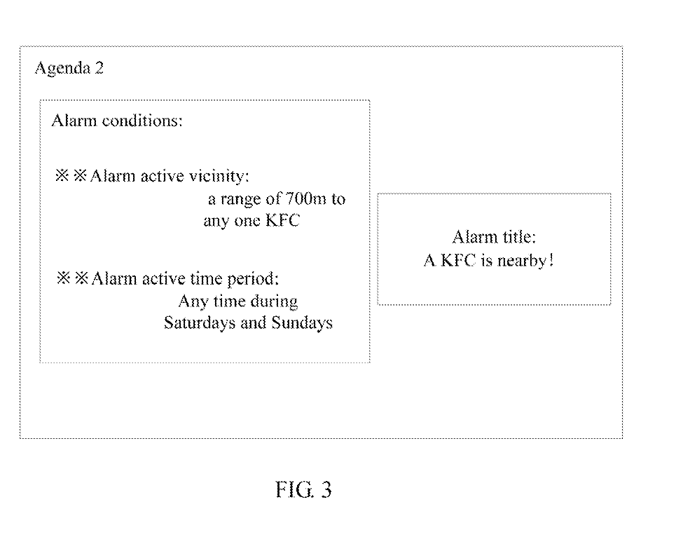

FIG. 2 and FIG. 3 illustrates one example of a graphical user interface showing an agenda on the mobile telephone 1. In an example, a user may want to be reminded of an intended destination (e.g., a train stop or a bus stop) during the weekdays (Monday-Friday) to avoid missing the intended destination due to some reasons, such as falling asleep or reading a newspaper. An agenda 1 as illustrated in FIG. 2 may be set to remind the user about an approaching intended destination. In FIG. 2, The alarm conditions of the agenda 1 include an alarm active vicinity and an alarm active time period. The alarm active vicinity comprises alerting a user through one or more methods as will be described below about an approaching intended destination within a predetermined vicinity. The alarm active period comprises alerting a user about reaching an intended destination in a predetermined range of time. For example, the alarm active vicinity of the agenda 1 may be set to a range of 500 m to the user's destination—XX station, and the alarm active time period of the agenda 1 may be set to 8:00 AM˜9:00 AM during the weekdays. Furthermore, an alarm title of the agenda 1 may be set as “Attention, please! The approaching XX station.”

In another example, if a user is fond of a restaurant, such as Kentucky Fried Chicken (KFC®), the user may want to be reminded if there are any one KFC® near the vicinity of the user during his traveling on weekends (Saturdays and Sundays). Thus, an agenda 2 of FIG. 3 is set. In FIG. 3, the alarm conditions of the agenda 2 also include an alarm active vicinity and an alarm active time period. The alarm active vicinity of the agenda 2 may be set to a range of 700 m to any one KFC®, and the alarm active time period of the agenda 2 is at any time during Saturdays and Sundays, for example. Furthermore, an alarm title of the agenda 2 in the embodiment is set as “A KFC® is nearby,” for example.

The storing module 202 is configured for storing the at least one agenda, the alarm conditions, and the alarm title of the at least one agenda into a hard disk, a memory card, or any other storage device electronically connected to the mobile telephone 1.

The positioning module 203 is configured for receiving positioning signals from the GPS 10, and determining a current location of the mobile telephone 1 according to the positioning signals.

The trigger alarm module 204 is configured for detecting if all the alarm conditions of the at least one agenda have been satisfied. In one exemplary embodiment, the trigger alarm module 204 reads a first alarm condition of one agenda, such as the alarm active vicinity of the agenda, and determines if a current location of the mobile telephone 1 is within the alarm active vicinity. In addition, the trigger alarm module 204 further determines if a current system time of the mobile telephone 1 is within the alarm active time period if the agenda has additional alarm conditions, such as the alarm active time period.

The reminding module 205 is configured for reminding the user about the agenda via an alarm output mode if all the alarm conditions of the agenda have been satisfied. In one embodiment, the alarm output mode may be preconfigured as ring mode, vibrate mode, displaying, for example.

In one embodiment, if an alarm title of the agenda is set, the reminding module 205 is further configured for displaying the alarm title on a screen of the mobile telephone 1 when reminding the user about the agenda.

The determining module 206 is configured for determining if all the alarm conditions of the agenda remain satisfied after the reminding module 205 reminds the user about the agenda.

The updating module 207 is configured for setting the agenda to be in a non-executable state if all the alarm conditions of the agenda remain satisfied, or setting the agenda to be in an executable state if at least one of the alarm conditions of the agenda has not been satisfied.

In addition, the determining module 206 is further configured for determining if the agenda remains active. In an example, if the alarm active time period of an agenda is only May 1, 2008, then the agenda is not active after May 1, 2008.

In addition, the updating module 207 is further configured for deleting the agenda if the agenda is not active.

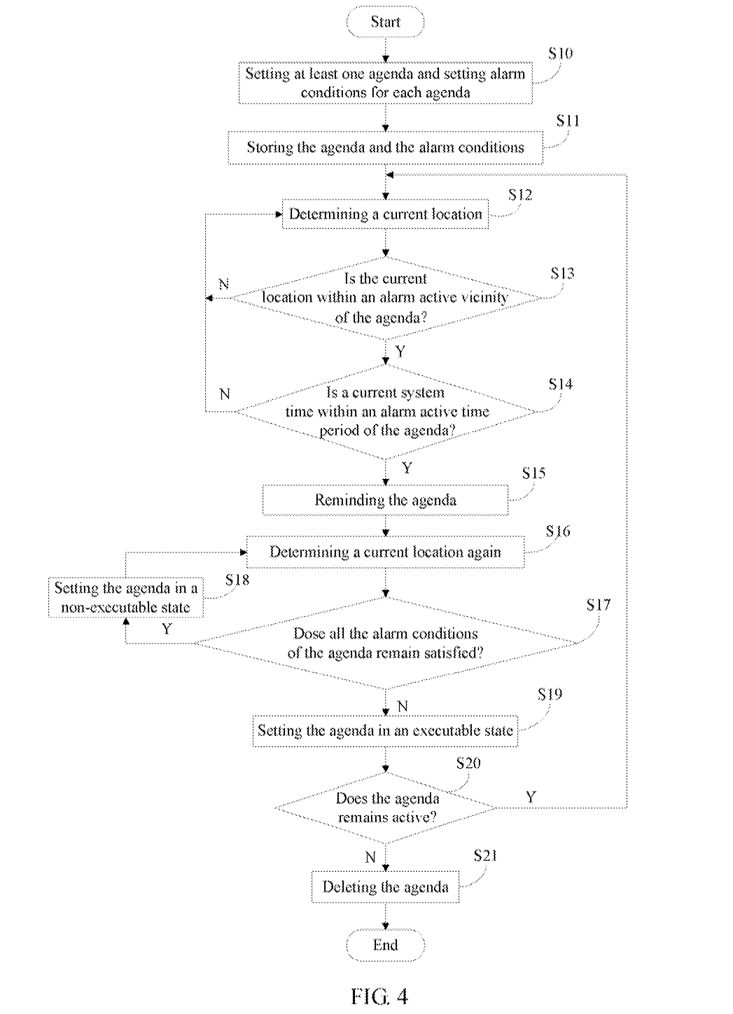

FIG. 4 is a flowchart illustrating one embodiment of a method for managing agendas in the mobile telephone 1. Depending on the embodiment, additional blocks may be added, others removed, and the ordering of the blocks may be changed.

In block S10, the setting module 201 may set a agenda (the agenda 2, for example) and further set alarm conditions and an alarm title for the agenda. In one embodiment, the alarm conditions include an alarm active vicinity and an alarm active time period.

In block S11, the storing module 202 stores the agenda, the alarm conditions, and the alarm title of the agenda into a hard disk, a memory card, or any other storage device. The storage device may be internal or external to the mobile telephone 1 depending on the embodiment.

In block S12, the positioning module 203 receives positioning signals from the GPS 10 of the mobile telephone 1, and determines a current location of the mobile telephone 1 according to the positioning signals.

In block S13, the trigger alarm module 204 reads a first alarm condition of the agenda, and determines if the current location of the mobile telephone 1 is within the alarm active vicinity (e.g., 700 m to any one KFC®). The flow will move to the block S12 if the current location is not within the alarm active vicinity. Otherwise, the flow will move to block S14 described below if the current location is within the alarm active vicinity.

In addition, if the agenda has an additional alarm condition, such as the alarm active time period, in block S14, the trigger alarm module 204 further determines if a current system time of the mobile telephone 1 is within the alarm active time period (any time during the weekends, for example). The flow will move to the block S12 if the current time is not within the alarm active time period. Otherwise, the flow will move to block S15 if the current time is within the alarm active time period.

In block S15, the reminding module 205 reminds a user about the agenda via an alarm output mode, and further displays the alarm title ( “A KFC® is nearby,” for example).

In block S16, the positioning module 203 receives positioning signals from the GPS 10 of the mobile telephone 1, and determining a current location of the mobile telephone 1 again according to the positioning signals.

In block S17, the determining module 206 determines that if all the alarm conditions of the agenda remain satisfied. The flow will move to block S18 if all the alarm conditions of the agenda remain satisfied. Otherwise, the flow will move to block S19 if at least one of the alarm conditions of the agenda has not been satisfied.

In block S18, the updating module 207 sets the agenda 2 to be in a non-executable state. In block S19, the updating module 207 sets the agenda 2 to be in an executable state.

In block S20, the determining module 206 determines if the agenda remains active. In an example, if the alarm active time period of the agenda is only May 1, 2008, then the agenda is not active after May 1, 2008. The flow will move to the block S12 if the agenda remains active. Otherwise, the flow will move to block 21 if the agenda is not active.

In block S21, the updating module 207 deletes the agenda.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system for managing agendas in a mobile device comprising a global position system (GPS), the system comprising:
a setting module configured for setting at least one agenda, and setting alarm conditions for the at least one agenda, the alarm conditions comprising an alarm active vicinity;
a storing module configured for storing the at least one agenda and the alarm conditions of the at least one agenda into a storage device;
a positioning module configured for receiving positioning signals from the GPS, and determining a current location of the mobile device according to the positioning signals;
a trigger alarm module configured for detecting if all the alarm conditions of the at least agenda have been satisfied; and
a reminding module configured for reminding a user about the agenda upon the condition that all the alarm conditions of the agenda have been satisfied.

2. The computing system of claim 1, wherein the setting module is further configured for setting an alarm title for the at least one agenda, the reminding module further configured for displaying the alarm title via a display device of the mobile device when reminding the user about the agenda.

3. The computing system of claim 1, wherein the alarm conditions further comprise an alarm active time period.

4. The computing system of claim 3, further comprising:
a determining module configured for determining if all the alarm conditions of the agenda remain satisfied after the reminding module reminds the user about the agenda; and
an updating module configured for setting the agenda in a non-executable state upon the condition that all the alarm conditions of the agenda remain satisfied, and setting the agenda in an executable state upon the condition that one of the alarm conditions of the agenda has not been satisfied.

5. The computing system of claim 4, wherein:
the determining module is further configured for determining if the agenda remains active; and
the updating module is further configured for deleting the agenda upon the condition that the agenda is not active.

6. A method for managing agendas in a mobile device, comprising:
(a) setting at least one agenda, and setting alarm conditions of the at least one agenda, the alarm conditions comprising an alarm active vicinity;
(b) storing the at least one agenda and the alarm conditions of the at least one agenda into a storage device;
(c) receiving positioning signals from the GPS, and determining a current location of the mobile device according to the positioning signals;
(d) detecting if all the alarm conditions of the agenda have been satisfied; and
(e) reminding a user about the at least one agenda upon the condition that all the alarm conditions of the agenda are satisfied.

7. The method of claim 6, further comprising a block after the block (a):
setting an alarm title of the at least one agenda, and displaying the alarm title when reminding the user about the agenda.

8. The method of claim 6, wherein the alarm conditions further comprise an alarm active time period.

9. The method of claim 8, further comprising:
determining if all the alarm conditions of the agenda remain satisfied; and
setting the agenda in a non-executable state upon the condition that all the alarm conditions of the agenda remain satisfied and setting the agenda in an executable state upon the condition that one of the alarm conditions of the agenda has not been satisfied.

10. The method of claim 9, further comprising:
determining if the agenda remains active; and
deleting the agenda upon the condition that the agenda is not active.

11. A storage medium having stored thereon instructions that, when executed by a mobile device, causing the mobile device to perform a method comprising:
(a) setting at least one agenda, and setting alarm conditions of the at least one agenda, the alarm conditions comprising an alarm active vicinity;
(b) storing the at least one agenda and the alarm conditions of the at least one agenda into a storage device;
(c) receiving positioning signals from the GPS, and determining a current location of the mobile device according to the positioning signals;
(d) detecting if all the alarm conditions of the agenda have been satisfied; and
(e) reminding a user about the at least one agenda upon the condition that all the alarm conditions of the agenda are satisfied.

12. The medium of claim 11, wherein the method further comprises a block after the block (a):
setting an alarm title of the at least one agenda, and displaying the alarm title when reminding the user about the agenda.

13. The storage medium of claim 11, wherein the alarm conditions further comprise an alarm active time period.

14. The medium of claim 13, wherein the method further comprises blocks after the block (e):
determining if all the alarm conditions of the agenda remain satisfied; and
setting the agenda in a non-executable state upon the condition that all the alarm conditions of the agenda remain satisfied and setting the agenda in an executable state upon the condition that one of the alarm conditions of the agenda has not been satisfied.

15. The medium of claim 14, wherein the method further comprises:
determining if the agenda remains active; and
deleting the agenda upon the condition that the agenda is not active.
